(19) United States
(12) Patent Application Publication
(10) Pub. No.: US 2023/0021314 A1
(43) Pub. Date: Jan. 26, 2023

(54) POSTURE CHANGING DEVICE, UNMANNED AERIAL VEHICLE, AND POSTURE CHANGING METHOD

(71) Applicant: Toyo Seikan Co., Ltd., Tokyo (JP)

(72) Inventors: Atsushi KOMINAMI, Kanagawa (JP); Souji ARAKI, Kanagawa (JP)

(21) Appl. No.: 17/785,415

(22) PCT Filed: Oct. 9, 2020
(86) PCT No.: PCT/JP2020/038392

§ 371 Date: Jun. 15, 2022

(30) Foreign Application Priority Data
Dec. 16, 2019 (JP) 2019-226683

(51) Int. Cl. G05D 1/00; G05D 1/10; B64D 47/00; B64C 39/02

(52) U.S. Cl. CPC G05D 1/0094; G05D 1/101; B64D 47/00; B64C 39/024; B64C 2201/12

(57) ABSTRACT

Provided is a posture changing device for changing a posture of an aerosol container mounted on an unmanned aerial vehicle, the posture changing device including: a posture selecting unit for selecting a posture of the aerosol container from a plurality of candidate postures; and a posture changing unit for changing a posture of the aerosol container to the posture selected from the plurality of candidate postures. Also provided is a posture changing method for changing a posture of an aerosol container mounted on an unmanned aerial vehicle, the posture changing method including: selecting a posture of the aerosol container from a plurality of candidate postures; and changing a posture of the aerosol container to the posture selected from the plurality of candidate postures.

### BACKGROUND

### 1. Technical Field

The present invention relates to a posture changing device, an unmanned aerial vehicle, and a posture changing method.

### 2. Related Art

Conventionally, an unmanned aerial vehicle on which a container is mounted has been known (for example, see Patent Literature 1).

Patent Document 1: Japanese Translation Publication of PCT Route Patent Application No. 2018-516197

### Problem to be Solved

In a conventional unmanned aerial vehicle, it may be difficult to mount a container depending on the shape of the container.

### GENERAL DISCLOSURE

In a first aspect of the present invention, there is provided a posture changing device for changing a posture of an aerosol container mounted on an unmanned aerial vehicle, the posture changing device including: a posture selecting unit for selecting a posture of the aerosol container from a plurality of candidate postures; and a posture changing unit for changing a posture of the aerosol container to the posture selected from the plurality of candidate postures.

The posture selecting unit may have, as the plurality of candidate postures, a posture in which a longitudinal direction of the aerosol container is substantially horizontal and a posture in which the longitudinal direction of the aerosol container is substantially vertical.

The posture changing unit may have, as the plurality of candidate postures, an upright posture in which the longitudinal direction of the aerosol container is substantially vertical and an inverted posture in which the longitudinal direction of the aerosol container is substantially vertical.

The posture changing device may include a state detecting unit for detecting a flight state of the unmanned aerial vehicle.

The posture changing unit may permit changing the posture of the aerosol container when the state detecting unit detects that the unmanned aerial vehicle is flying.

The posture changing unit may change the posture of the aerosol container substantially horizontal or substantially vertical while the unmanned aerial vehicle is flying.

The posture changing device may include an acquiring unit for acquiring information on shapes of the unmanned aerial vehicle and the aerosol container. When the aerosol container is longer than the leg of the unmanned aerial vehicle and the unmanned aerial vehicle is in a landing state, the posture changing device may maintain the posture of the aerosol container substantially horizontally.

The posture changing device may further include a distance measuring unit for measuring a distance to the unmanned aerial vehicle. The posture changing device may maintain the posture of the aerosol container substantially horizontally in accordance with the distance measured by the distance measuring unit.

The posture changing unit may maintain the posture of the aerosol container substantially vertically when the aerosol container is used.

In a second aspect of the present invention, there is provided an unmanned aerial vehicle including an aerosol container and a posture changing device according to the first aspect of the present invention.

The unmanned aerial vehicle may have a leg for landing. The aerosol container may be longer than the leg of the unmanned aerial vehicle.

The aerosol container may be held entirely inside the leg of the unmanned aerial vehicle when in a substantially horizontal posture, and held at least partly outside the leg of the unmanned aerial vehicle when in a substantially vertical posture.

In a third aspect of the present invention, there is provided a posture changing method for changing a posture of an aerosol container mounted on an unmanned aerial vehicle, the posture changing method including: selecting a posture of the aerosol container from a plurality of candidate postures; and changing a posture of the aerosol container to the posture selected from the plurality of candidate postures.

The changing a posture may be executed while the unmanned aerial vehicle is flying.

The summary clause does not necessarily describe all necessary features of the embodiments of the present invention. The present invention may also be a sub-combination of the features described above.

### BRIEF DESCRIPTION OF THE DRAWINGS

FIG. 1A shows an example of the configuration of an unmanned aerial vehicle 100.

FIG. 1B shows an example of a steering system 400 of the unmanned aerial vehicle 100.

FIG. 1C shows an example of the operation flowchart for changing the posture of a container 70.

FIG. 1D is an example of a block diagram showing the configuration of the posture changing device 30.

FIG. 2A shows an example of the configuration of the unmanned aerial vehicle 100 which holds the container 70 substantially vertically.

FIG. 2B shows an example of the configuration of the unmanned aerial vehicle 100 which holds the container 70 substantially horizontally.

FIG. 2C illustrates a method for controlling the posture changing device 30.

FIG. 3 shows an example of the configuration of the unmanned aerial vehicle 100 according to another embodiment.

FIG. 4 shows an example of an unmanned aerial vehicle 100 including a rotation mechanism 36.

### DESCRIPTION OF EXEMPLARY EMBODIMENTS

Hereinafter, the present invention will be described through embodiments of the invention; however, the following embodiments do not limit the claimed inventions. Moreover, not all combinations of features described in the embodiments are essential to the solutions of the invention.

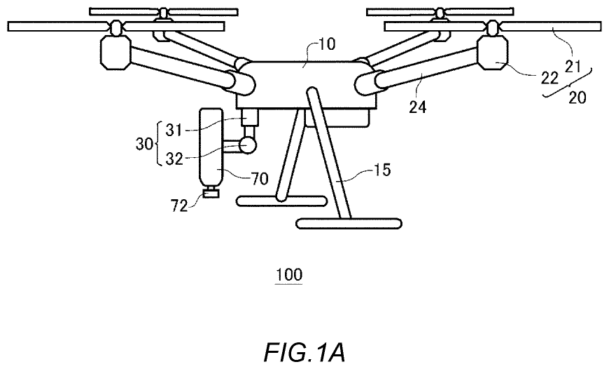

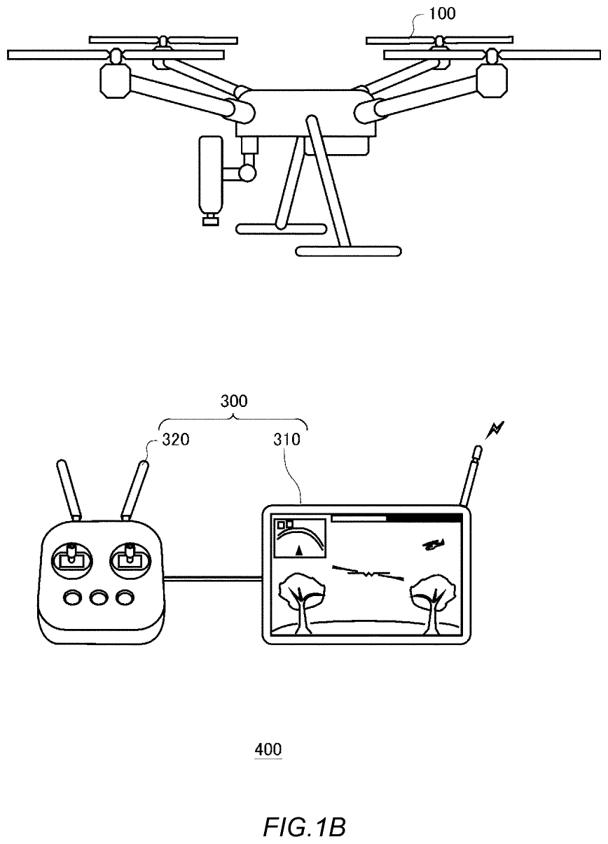

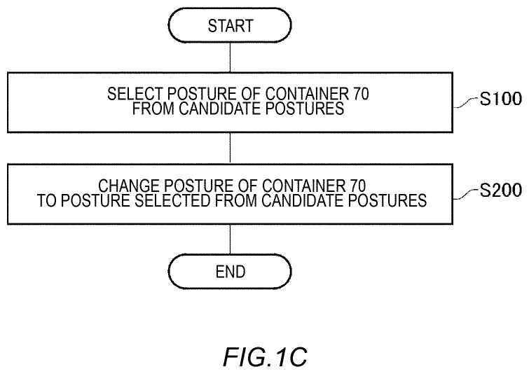

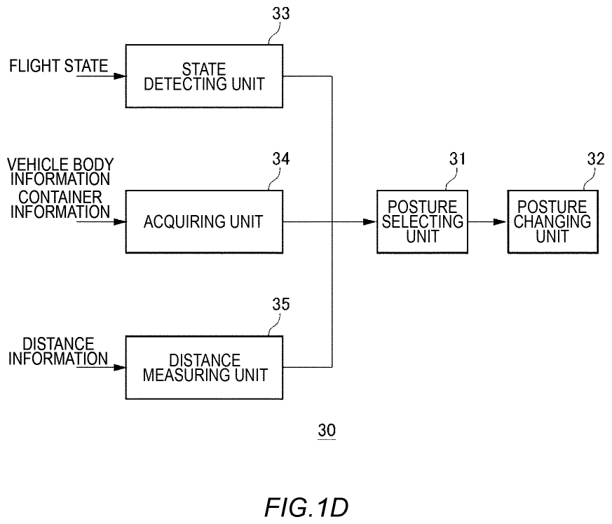

FIG. 1A shows an example of the configuration of an unmanned aerial vehicle 100. The unmanned aerial vehicle 100 of this example includes a main body 10, a leg 15, a propulsion portion 20, an arm 24, and a posture changing device 30. The unmanned aerial vehicle 100 holds a container 70.

The unmanned aerial vehicle 100 is a flying object that flies in the air. The unmanned aerial vehicle 100 discharges the contents contained in the container 70.

The main body 10 stores various control circuits, a power supply, and the like of the unmanned aerial vehicle 100. The main body portion 10 may also function as a structure for coupling components of the unmanned aerial vehicle 100. The main body 10 of this example is coupled to the propulsion portion 20 by the arm 24.

The propulsion portion 20 generates a propulsive force for propelling the unmanned aerial vehicle 100. The propulsion portion 20 has a rotary wing 21 and a rotary drive portion 22. The unmanned aerial vehicle 100 of this example includes four propulsion portions 20. The propulsion portion 20 is attached to the main body 10 via the arm 24. The unmanned aerial vehicle 100 may be a flying object provided with a fixed wing as the propulsion portion 20.

The rotary wing 21 generates a propulsive force by rotation. Although four rotary wings 21 are provided around the main body 10, the way of arranging the rotary wings 21 is not limited to this example The rotary wing 21 is provided at the tip of the arm 24 via the rotary drive portion 22.

The rotary drive portion 22 has a power source such as a motor and drives the rotary wing 21. The rotary drive portion 22 may have a brake mechanism for the rotary wing 21. The rotary wing 21 and the rotary drive portion 22 may be directly attached to the main body 10 without the arm 24.

The arm 24 extends radially from the main body 10. The unmanned aerial vehicle 100 of this example includes four arms 24 corresponding to the four propulsion portions 20. The arm 24 may be fixed or movable. Another component, such as a camera, may be fixed to the arm 24.

The leg 15 is a leg for landing that is coupled to the main body 10 and maintains the posture of the unmanned aerial vehicle 100 at the time of landing. The leg 15 maintains the posture of the unmanned aerial vehicle 100 with the propulsion portion 20 stopped. The unmanned aerial vehicle 100 of this example has, but is not limited to, two legs 15.

The container 70 is a container to be filled with contents. In one example, the container 70 is an aerosol container which discharges the contents filled therein. The aerosol container ejects its contents by the gas pressure of a liquefied gas or a compressed gas filled therein. The container 70 of this example is an aerosol can made of metal, but may be a pressure resistant plastic container. The container 70 of this example has a discharge portion 72 for discharging the contents. For example, the discharge portion 72 is a nozzle that discharges the contents.

As the propellant, a liquefied gas such as hydrocarbon (liquefied petroleum gas) (LPG), dimethyl ether (DME), or fluorocarbon (HFO-1234ze), or a compressed gas such as carbon dioxide (CO₂), nitrogen (N₂) or nitrous oxide (N₂O) may be used.

The posture changing device 30 includes a posture selecting unit 31 and a posture changing unit 32. The posture changing device 30 changes the posture of the container 70 mounted on the unmanned aerial vehicle 100.

The posture selecting unit 31 selects a posture of the container 70 from a plurality of candidate postures. In one example, the posture selecting unit 31 selects a posture corresponding to the situation or use. For example, the posture selecting unit 31 selects a posture of the container 70 in accordance with the situation such as whether the unmanned aerial vehicle 100 is flying or landing. The posture selecting unit 31 may select a posture of the container 70 in accordance with the situation such as whether discharge of the container 70 is permitted. The posture selecting unit 31 may also select a posture of the container 70 in accordance with the use of the container 70 such as whether it is used during flight. Although the posture selecting unit 31 of this example is provided outside the main body 10, it may be provided inside the main body 10 or in another component.

The plurality of candidate postures include two or more postures of the container 70. For example, the plurality of candidate postures include postures in which the longitudinal direction of the container 70 is substantially vertical and substantially horizontal. Herein, “substantially vertical” does not need to be strictly vertical, and for example, a difference of ±10 degrees is allowed. The same applies to “substantially horizontal”. The plurality of candidate postures may also include a posture in which the longitudinal direction of the container 70 is inclined at any angle. The plurality of candidate postures may include a posture of the container 70 according to the discharge direction. For example, an appropriate candidate posture of the container 70 is prepared in accordance with the discharge direction and the contents to be discharged.

The posture changing unit 32 changes the posture of the container 70 to a posture selected from the plurality of candidate postures. For example, the posture changing unit 32 changes the longitudinal direction of the container 70 from substantially vertical to substantially horizontal. Alternatively, the posture changing device 30 may change the posture of the container 70 such that the position of the discharge portion 72 of the container 70 is inverted. In this case, the longitudinal axis of the container 70 may be rotated by 180 degrees.

The posture changing device 30 of this example directly holds the container 70, but is not limited to this. The posture changing device 30 may change the posture of the container 70 by changing the posture of an accommodating portion that accommodates the container 70. The material of the accommodating portion is not particularly limited as long as it can hold the container 70. In one example, the material of the accommodating portion includes a metal such as aluminum, a plastic, and a strong and lightweight material such as carbon fiber. Further, the material of the accommodating portion is not limited to a hard material, but may include a soft material, for example, a rubber material such as silicone rubber or urethane foam. The accommodating portion may include a temperature adjustment mechanism for heating, keeping warm or cooling the container 70.

The unmanned aerial vehicle 100 may be provided with a camera for photographing the surroundings. The camera of the unmanned aerial vehicle 100 may be a fixed camera or a movable camera. In one example, the camera is attached to a side surface of the main body 10. The camera may be attached to a portion other than the main body 10, such as the leg 15. The user of the unmanned aerial vehicle 100 can operate the unmanned aerial vehicle 100 based on an image captured by the camera. Alternatively, the user of the unmanned aerial vehicle 100 may directly see and steer the unmanned aerial vehicle 100.

FIG. 1B shows an example of a steering system 400 of the unmanned aerial vehicle 100. The steering system 400 of this example includes the unmanned aerial vehicle 100 and a terminal device 300. The terminal device 300 includes a display 310 and a controller 320.

The display 310 displays an image captured by a camera mounted on the unmanned aerial vehicle 100. When the unmanned aerial vehicle 100 is provided with a fixed camera and a movable camera, the display 310 may display the images captured by the respective cameras. For example, the display 310 displays the images of the fixed camera and the movable camera on divided screens. The display 310 may directly communicate with the unmanned aerial vehicle 100, or may indirectly communicate with the unmanned aerial vehicle 100 via the controller 320. The display 310 may be connected to an external server.

The display 310 may also display an image below the unmanned aerial vehicle 100. This makes it possible to know the distance between the unmanned aerial vehicle 100 and the landing surface. In one example, the user changes the posture of the container 70 in accordance with the image displayed on the display 310. For example, when there is a danger that the container 70 comes into contact with an obstacle, the posture of the container 70 is changed.

The controller 320 is operated by the user to steer the unmanned aerial vehicle 100. The controller 320 may provide an instruction to discharge the contents in addition to the instruction to fly the unmanned aerial vehicle 100. The controller 320 may instruct the posture changing device 30 to change the posture of the container 70. The controller 320 may be connected to the display 310 in a wired or wireless manner. A plurality of controllers 320 may be provided and selectively used for steering the unmanned aerial vehicle 100 and for controlling the discharge of the contents.

The unmanned aerial vehicle 100 of this example is manually steered by using the terminal device 300. However, the unmanned aerial vehicle 100 may be steered automatically by a program instead of being controlled manually. The user may directly see and steer the unmanned aerial vehicle 100 without using the screen displayed on the display 310. It is also possible to automatically control the steering of the unmanned aerial vehicle 100 and manually operate the discharge of the contents. The unmanned aerial vehicle 100 may automatically change the posture of the container 70 in accordance with the situation.

FIG. 1C shows an example of the operation flowchart for changing the posture of the container 70. In the unmanned aerial vehicle 100 of this example, the posture change of the container 70 is executed by step S100 and step S200.

In step S100, a posture of the container 70 is selected from a plurality of candidate postures. In step S100, a posture different from the current posture of the container 70 may be selected. The posture of the container 70 may be selected in accordance with the flight state of the unmanned aerial vehicle 100, the shape of the vehicle body, the shape of the container 70, and the like.

In step S200, the posture of the container 70 is changed to the posture selected from the plurality of candidate postures. For example, the stage of changing the posture of step S200 is executed during the flight of the unmanned aerial vehicle 100. After the posture of the container 70 is changed in step S200, the contents of the container 70 may be discharged. Step S100 and step S200 may be executed repeatedly during operation of the unmanned aerial vehicle 100.

FIG. 1D is an example of a block diagram showing the configuration of the posture changing device 30. The posture changing device 30 of this example includes a state detecting unit 33, an acquiring unit 34, and a distance measuring unit 35 in addition to the posture selecting unit 31 and the posture changing unit 32.

The state detecting unit 33 detects the flight state of the unmanned aerial vehicle 100. In one example, the flight state of the unmanned aerial vehicle 100 indicates a state of the unmanned aerial vehicle 100, such as whether the unmanned aerial vehicle 100 is flying, in a landing state, or stopped. For example, the state detecting unit 33 detects a flight state of the unmanned aerial vehicle 100 from a flight control unit of the unmanned aerial vehicle 100. The state detecting unit 33 may also detect a flight state of the unmanned aerial vehicle 100 from position information of a global positioning system (GPS) or the like. The state detecting unit 33 may be provided in the main body 10.

The acquiring unit 34 acquires shape information on the shape of the unmanned aerial vehicle 100 or the container 70. For example, the acquiring unit 34 acquires the longitudinal length of the container 70. The acquiring unit 34 may acquire the lateral length of the container 70 (that is, the width of the container 70). The acquiring unit 34 may acquire the length of the leg 15 or the length of the arm 24 as the shape of the unmanned aerial vehicle 100. For example, the acquiring unit 34 acquires shape information of the unmanned aerial vehicle 100 or the container 70 by photographing the container 70 with a camera. The acquiring unit 34 may acquire the shape information of the unmanned aerial vehicle 100 or the container 70 from information registered in advance. The acquiring unit 34 may acquire real-time information such as air resistance as needed. The acquiring unit 34 may be provided in the main body 10.

The distance measuring unit 35 measures distance information of the unmanned aerial vehicle 100. In one example, the distance measuring unit 35 measures a distance to the unmanned aerial vehicle 100. For example, the distance measuring unit 35 measures the distance between the lower surface of the main body 10 and the landing surface. Alternatively, the distance measuring unit 35 may measure the distance between the unmanned aerial vehicle 100 and an obstacle. Thus, even when an obstacle such as an electric wire or a roof approaches below the unmanned aerial vehicle 100, contact can be avoided. The distance measuring unit 35 may be provided in the main body 10. For example, the distance measuring unit 35 is provided on the lower surface side of the main body 10. When the acquiring unit 34 can measure any distance, the acquiring unit 34 may also function as the distance measuring unit 35.

The posture selecting unit 31 selects a posture of the container 70 based on information acquired by at least one of the state detecting unit 33, the acquiring unit 34, or the distance measuring unit 35. For example, when the state detecting unit 33 detects the landing state of the unmanned aerial vehicle 100, the posture selecting unit 31 selects a posture which prevents the container 70 from interfering at the time of landing. The posture selecting unit 31 may select a posture of the container 70 in accordance with the shape of the container 70 acquired by the acquiring unit 34. Further, the posture selecting unit 31 may select a posture of the container 70 in accordance with the distance information acquired by the distance measuring unit 35.

The posture changing unit 32 changes the posture of the container 70 to the posture selected by the posture selecting unit 31. The posture changing unit 32 changes the posture of the container 70 based on the flight state of the unmanned aerial vehicle 100. When the state detecting unit 33 detects that the unmanned aerial vehicle 100 is flying, the posture changing unit 32 may permit a change of the posture of the container 70. For example, the posture changing unit 32 changes the posture of the container 70 to be substantially horizontal or substantially vertical during the flight of the unmanned aerial vehicle 100.

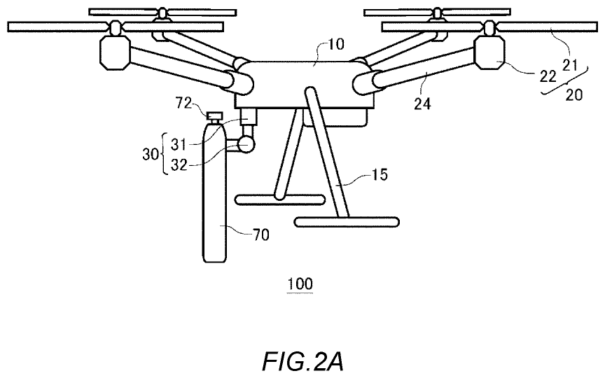

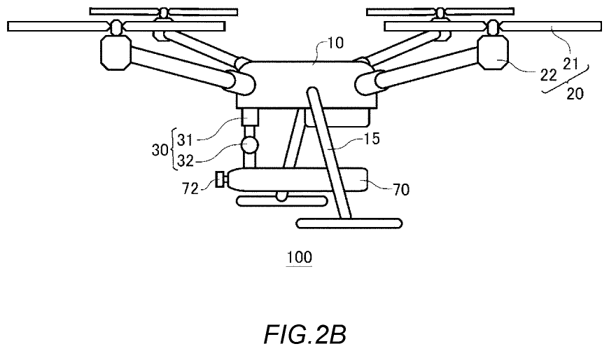

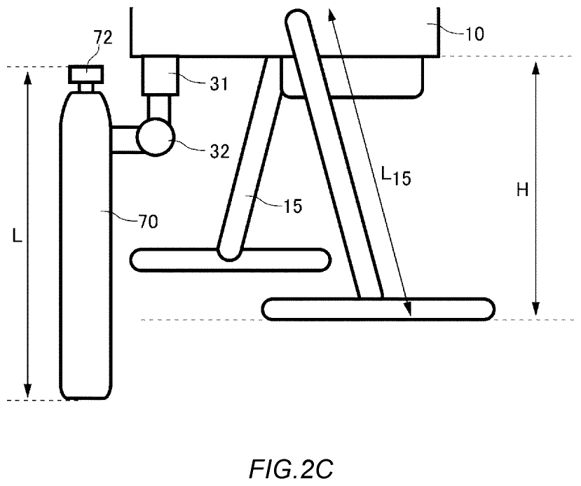

FIG. 2A shows an example of the configuration of the unmanned aerial vehicle 100 which holds the container 70 substantially vertically. The unmanned aerial vehicle 100 of this example differs from the example of FIG. 1A in that it holds a longer container 70. In this example, the differences from the example of FIG. 1A will be described in particular.

The posture changing device 30 controls the container 70 so that the longitudinal direction of the container 70 becomes substantially vertical or substantially horizontal. In the posture changing device 30 of this example, when the container 70 is held so that the longitudinal direction of the container 70 is substantially vertical, the container 70 may come into contact with the landing surface; therefore, the substantially vertical posture is prohibited in the landing state.

The landing state may include a state where the unmanned aerial vehicle 100 has started preparation for landing in addition to a state where the unmanned aerial vehicle 100 is landing. The start of preparation for landing may include when the unmanned aerial vehicle 100 is instructed to land or when the unmanned aerial vehicle 100 starts decelerating or the like for landing. The unmanned aerial vehicle 100 maintains the container 70 substantially horizontally before landing to avoid contact with the container 70.

The posture changing unit 32 maintains the posture of the container 70 substantially vertically when the container 70 is used. The posture changing unit 32 changes the posture of the container 70 to an upright posture or an inverted posture in accordance with the structure of the container 70. For example, when the container 70 has a structure capable of discharging in an inverted posture, the posture changing unit 32 changes the container 70 to the inverted posture at the time of use.

FIG. 2B shows an example of the configuration of the unmanned aerial vehicle 100 which holds the container 70 substantially horizontally. The unmanned aerial vehicle 100 of this example differs from the case in FIG. 2A in that the container 70 is held in a substantially horizontal posture compatible with the landing state. The posture changing device 30 of this example holds the container 70 in a posture in which the longitudinal direction of the container 70 is substantially horizontal.

As described above, the unmanned aerial vehicle 100 is provided with the posture changing device 30, so that a container 70 longer than the leg 15 can be mounted. Accordingly, the variety of shapes of the container 70 that can be mounted on the unmanned aerial vehicle 100 increases. In addition, when the container 70 is maintained substantially horizontally, the air resistance of the container 70 is reduced, which makes the container 70 less susceptible to wind.

FIG. 2C illustrates a method for controlling the posture changing device 30. The figure is an enlarged view of an area around the leg 15 of the unmanned aerial vehicle 100 and the container 70.

Length L represents the longitudinal length of the container 70. The length L is an example of information on the shape of the container 70. The length L of this example is longer than the leg 15 of the unmanned aerial vehicle 100. The information of the length L may be acquired by the acquiring unit 34 and transmitted to the posture selecting unit 31. The acquiring unit 34 may store shape information of the container 70 in advance and automatically acquire shape information by identifying the type of the mounted container 70.

Height H is the height from the landing surface to the lower surface of the main body 10. The size of the space below the main body 10 can be recognized from the height H. The information of the height H may be acquired by the distance measuring unit 35 and transmitted to the posture selecting unit 31. The acquiring unit 34 may store shape information of the unmanned aerial vehicle 100 in advance and automatically acquire shape information by identifying the type of the mounted unmanned aerial vehicle 100.

Length L₁₅ is the length of the leg 15. The length L₁₅ may be acquired by the acquiring unit 34 and transmitted to the posture selecting unit 31. When the length L₁₅ of the leg 15 is variable, the acquiring unit 34 updates it to the latest information as needed in accordance with the expansion and contraction of the leg 15.

The posture changing device 30 maintains the posture of the container 70 substantially horizontally in accordance with the distance measured by the distance measuring unit 35. For example, when the length L of the container 70 is longer than the height H, the posture changing device 30 uses the distance measuring unit 35 to maintain the posture of the container 70 substantially horizontally when the unmanned aerial vehicle 100 enters the landing state.

The posture changing device 30 maintains the posture of the container 70 substantially horizontally when the length of the container 70 is longer than the length L₁₅ of the leg 15 of the unmanned aerial vehicle 100 and the unmanned aerial vehicle 100 is in the landing state. This enables the unmanned aerial vehicle 100 to realize safe landing while preventing interference of the container 70.

When in the substantially horizontal posture, the container 70 is held entirely inside the leg 15 of the unmanned aerial vehicle 100. The area inside the leg 15 refers to an area where the container 70 does not come into contact with the landing surface when the unmanned aerial vehicle 100 lands. For example, the area inside the leg 15 is an area below the main body 10 and within a range of the height H from the lower surface of the main body 10.

When in the substantially vertical posture, the container 70 is held at least partly outside the leg 15 of the unmanned aerial vehicle 100. The area outside the leg 15 refers to an area where the container 70 comes into contact with the landing surface when the unmanned aerial vehicle 100 lands. For example, the area outside the leg 15 is an area outside the range of the height H from the lower surface of the main body 10. The unmanned aerial vehicle 100 can hold the container 70 outside the leg 15 during flight.

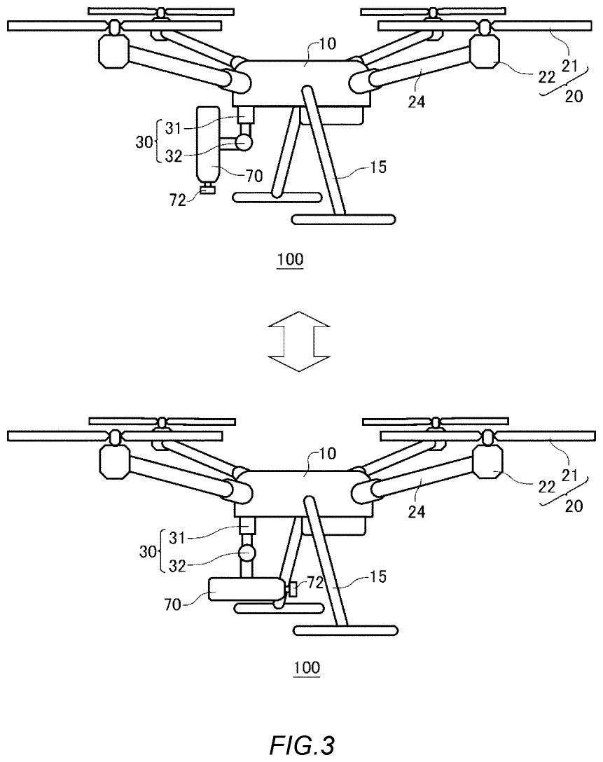

FIG. 3 shows an example of the configuration of an unmanned aerial vehicle 100 according to another embodiment. The unmanned aerial vehicle 100 of this example holds the container 70 upside down.

The posture changing device 30 holds the container 70 with the discharge portion 72 of the container 70 facing downward. The posture changing device 30 may hold it with the discharge portion 72 facing obliquely downward. The container 70 of this example is an inverting can for use while being held with the discharge portion 72 facing downward.

The unmanned aerial vehicle 100 holds the container 70 so that the posture of the container 70 is substantially vertical or substantially horizontal. For example, in order to reduce air resistance during flight, the unmanned aerial vehicle 100 holds the container 70 in a posture in which the longitudinal direction of the container 70 is substantially horizontal. The unmanned aerial vehicle 100 may also hold the container 70 in a posture in which the longitudinal direction of the container 70 is substantially horizontal so that the container 70 does not interfere with the landing surface at the time of landing. In this manner, the unmanned aerial vehicle 100 can maintain the container 70 in an appropriate posture in accordance with the flight state, the configuration of the vehicle body, and the like.

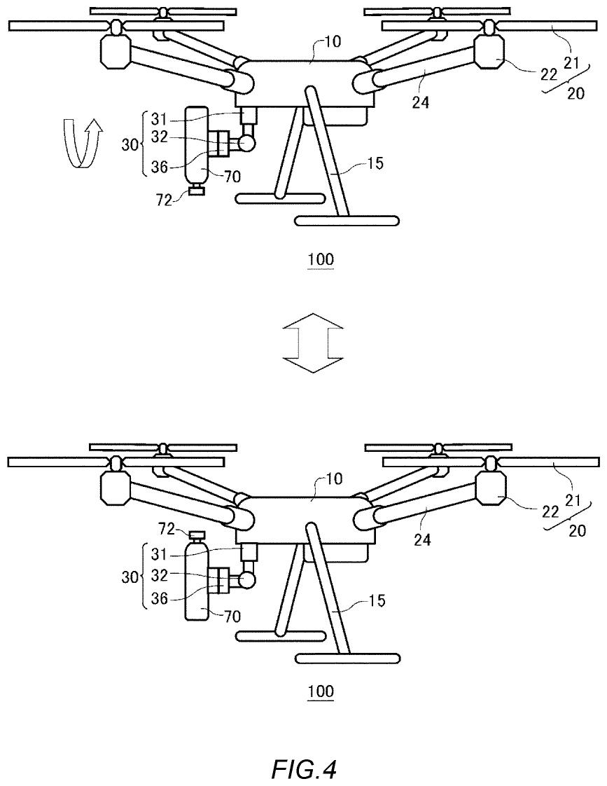

FIG. 4 shows an example of an unmanned aerial vehicle 100 including a rotation mechanism 36. The unmanned aerial vehicle 100 of this example uses the rotation mechanism 36 to change the posture of the container 70.

The posture changing device 30 has, as a plurality of candidate postures, an upright posture in which the longitudinal direction of the container 70 is substantially vertical, and an inverted posture in which the longitudinal direction of the container 70 is substantially vertical. The upright posture is a posture in which the discharge portion 72 of the container 70 faces upward. The inverted posture is a posture in which the discharge portion 72 of the container 70 faces downward.

The rotation mechanism 36 rotates the container 70 in a predetermined direction. In one example, the rotating mechanism 36 rotates the container 70 upside down. For example, the rotating mechanism 36 is attached to a side surface of the container 70, and inverts the container 70 by rotating the container 70 by 180 degrees.

The present invention has been described above using embodiments, but the technical scope of the present invention is not limited to the scope described in the above embodiments.

It is apparent to those skilled in the art that various modifications or improvements can be made to the above embodiments.

It is apparent from the claims that modes with such modifications or improvements may also be included in the technical scope of the present invention.

It should be noted that the order of execution of processes such as operations, procedures, steps, and stages in the devices, systems, programs, and methods shown in the claims, specification, and drawings may be realized in any order as long as there is no explicit indication such as “before”, “prior to”, etc., and the output of the previous process is not used in the later process. Even if an operation flow in the claims, specification, and drawings is described using “first”, “next”, or the like for convenience, it does not mean that it is essential to carry out the operation flow in this order.

### EXPLANATION OF REFERENCES

10: main body, 15: leg, 20: propulsion portion, 21: rotary wing, 22: rotary drive portion, 24: arm, 30: posture changing device, 31: posture selecting unit, 32: posture changing unit, 33: state detecting unit, 34: acquiring unit, 35: distance measuring unit, 36: rotation mechanism, 70: container, 72: discharge portion, 100: unmanned aerial vehicle, 300: terminal device, 310: display, 320: controller, 400: steering system

1. A posture changing device for changing a posture of an aerosol container mounted on an unmanned aerial vehicle, the posture changing device comprising:
a posture selecting unit for selecting a posture of the aerosol container from a plurality of candidate postures;
a posture changing unit for changing a posture of the aerosol container to a posture selected from the plurality of candidate postures.

2. The posture changing device according to claim 1, wherein
as the plurality of candidate postures, the posture selecting unit has:
a posture in which a longitudinal direction of the aerosol container is substantially horizontal; and
a posture in which the longitudinal direction of the aerosol container is substantially vertical.

3. The posture changing device according to claim 1, wherein
as the plurality of candidate postures, the posture changing unit has:
an upright posture in which a longitudinal direction of the aerosol container is substantially vertical; and
an inverted posture in which the longitudinal direction of the aerosol container is substantially vertical.

4. The posture changing device according to claim 1, wherein
the posture changing device comprises a state detecting unit for detecting a flight state of the unmanned aerial vehicle, and
the posture changing unit is configured to permit changing of the posture of the aerosol container when the state detecting unit detects that the unmanned aerial vehicle is flying.

5. The posture changing device according to claim 4, wherein the posture changing unit is configured to change a posture of the aerosol container to be substantially horizontal or substantially vertical while the unmanned aerial vehicle is flying.

6. The posture changing device according to claim 4, wherein
the posture changing device comprises an acquiring unit for acquiring information on shapes of the unmanned aerial vehicle and the aerosol container, and
the posture changing device is configured to maintain a posture of the aerosol container substantially horizontally when a length of the aerosol container is longer than a length a leg of the unmanned aerial vehicle and the unmanned aerial vehicle is in a landing state.

7. The posture changing device according to claim 1, wherein
the posture changing device further comprises a distance measuring unit for measuring a distance to the unmanned aerial vehicle, and
the posture changing device is configured to maintain a posture of the aerosol container substantially horizontally in accordance with a distance measured by the distance measuring unit.

8. The posture changing device according to claim 1, wherein the posture changing unit is configured to maintain a posture of the aerosol container substantially vertically when the aerosol container is used.

9. An unmanned aerial vehicle comprising:
an aerosol container; and
a posture changing device of the aerosol container, wherein
the posture changing device includes:
a posture selecting unit for selecting a posture of the aerosol container from a plurality of candidate postures; and
a posture changing unit for changing a posture of the aerosol container to a posture selected from the plurality of candidate postures.

10. The unmanned aerial vehicle according to claim 9, wherein
the unmanned aerial vehicle has a leg for landing, and
a length of the aerosol container is longer than the leg of the unmanned aerial vehicle.

11. The unmanned aerial vehicle according to claim 9, wherein
when in a substantially horizontal posture, the aerosol container is held entirely inside a leg of the unmanned aerial vehicle, and
when in a substantially vertical posture, the aerosol container is held at least partly outside a leg of the unmanned aerial vehicle.

12. A posture changing method for changing a posture of an aerosol container mounted on an unmanned aerial vehicle, the posture changing method comprising:
selecting a posture of the aerosol container from a plurality of candidate postures; and
changing a posture of the aerosol container to a posture selected from the plurality of candidate postures.

13. The posture changing method according to claim 12, wherein the changing a posture is executed while the unmanned aerial vehicle is flying.

14. The posture changing device according to claim 2, wherein
as the plurality of candidate postures, the posture changing unit has:
an upright posture in which a longitudinal direction of the aerosol container is substantially vertical; and
an inverted posture in which the longitudinal direction of the aerosol container is substantially vertical.

15. The posture changing device according to claim 2, wherein
the posture changing device comprises a state detecting unit for detecting a flight state of the unmanned aerial vehicle, and
the posture changing unit configured to permit changing of a posture of the aerosol container when the state detecting unit detects that the unmanned aerial vehicle is flying.

16. The posture changing device according to claim 5, wherein
the posture changing device comprises an acquiring unit for acquiring information on shapes of the unmanned aerial vehicle and the aerosol container, and
the posture changing device is configured to maintain a posture of the aerosol container substantially horizontally when a length of the aerosol container is longer than a length of a leg of the unmanned aerial vehicle and the unmanned aerial vehicle is in a landing state.

17. The posture changing device according to claim 2, wherein
the posture changing device further comprises a distance measuring unit for measuring a distance to the unmanned aerial vehicle, and
the posture changing device is configured to maintain a posture of the aerosol container substantially horizontally in accordance with a distance measured by the distance measuring unit.

18. The unmanned aerial vehicle according to claim 9, wherein
as the plurality of candidate postures, the posture selecting unit has:
a posture in which a longitudinal direction of the aerosol container is substantially horizontal; and
a posture in which the longitudinal direction of the aerosol container is substantially vertical.

19. The unmanned aerial vehicle according to claim 9, wherein
as the plurality of candidate postures, the posture changing unit has:
an upright posture in which a longitudinal direction of the aerosol container is substantially vertical; and
an inverted posture in which the longitudinal direction of the aerosol container is substantially vertical.

20. The unmanned aerial vehicle according to claim 9, wherein
the posture changing device comprises a state detecting unit for detecting a flight state of the unmanned aerial vehicle, and
the posture changing unit is configured to permit changing of a posture of the aerosol container when the state detecting unit detects that the unmanned aerial vehicle is flying.
